(19) United States
(12) Patent Application Publication
(10) Pub. No.: US 2022/0037700 A1
(43) Pub. Date: Feb. 3, 2022

(54) Device for Energy Distribution and/or Energy Conversion in a Hybrid or Electric Vehicle

(71) Applicant: EUGEN FORSCHNER GMBH, Spaichingen (DE)

(72) Inventors: Janosch ACKERMANN, Spaichingen (DE); Manuel BREMM, Spaichingen (DE); Hubert BISCHOF, Vaihingen (DE)

(21) Appl. No.: 17/277,038

(22) PCT Filed: Jun. 19, 2019
(86) PCT No.: PCT/EP2019/066310

§ 371 Date: Mar. 17, 2021

(30) Foreign Application Priority Data
Jun. 20, 2018 (DE) 10 2018 114 744.9
Aug. 30, 2018 (DE) 10 2018 121 244.5
Jan. 14, 2019 (DE) 20 2019 100 172.0

(51) Int. Cl. H01M 10/42; B60H 1/14; H01M 10/637; B60L 53/24; H01M 10/658; H01M 10/613

(52) U.S. Cl. CPC H01M 10/425; B60H 1/143; H01M 10/637; B60L 2210/10; H01M 10/658; H01M 10/613; B60Y 2400/302; B60L 53/24

(57) ABSTRACT

The invention relates to a device (101, 102, 103) for energy distribution and/or energy conversion, the device being arranged in a hybrid- or electric vehicle (10) having at least one vehicle interior (20) and at least one battery (40) for driving at least one electric drive motor (50). To improve the total energy balance of the hybrid- or electric vehicle (10), according to the invention the device (101, 102, 103) comprises a housing (110) in which at least one electronic, electric, electromechanical, or electrochemical device (121, 122, 131, 132, 133, 161, 162, 171, 172) is arranged, the waste heat of which, generated during the distribution and/or conversion of energy, is fed into a flow of heat transfer medium (210) which passes through the housing (110), said flow being connected at its outlet to the vehicle interior (20) and/or to the battery (40).

The invention relates to a device for energy distribution and/or energy conversion in a hybrid- or electric vehicle, according to the preamble of claim 1.

A device for air conditioning a vehicle interior of an electric vehicle is known, for example, from WO 2012/169 764 A2. In this known device, heat is recovered from various electrical air conditioning components of the electric vehicle.

The object of the invention is to create a device for energy distribution and/or energy conversion in a hybrid- or electric vehicle, by means of which the energy efficiency of a hybrid- or electric vehicle is significantly improved.

This object is achieved by a device having the features of claim 1. Advantageous refinements of the invention are specified in the dependent claims which refer to them.

The device according to the invention, having at least one energy distribution and/or protective unit, which is also sometimes termed a power distribution unit (PDU) in the technical field, and at least one DC/DC converter, is characterized in that it comprises at least one shared housing in which the at least one energy distribution and/or protective unit and the at least one DC/DC converter are arranged. Advantageously, at least one electronic, electrical, electromechanical or electrochemical device, in particular further high-voltage components, which generate further heat loss or waste heat, are arranged in the shared housing. The arrangement in a shared housing allows a direct connection of the different components to each other, such that the number of connector cables and/or connector plugs which were previously necessary between these components can be dispensed with, or at least reduced. The shared housing also allows for a very compact, space-, weight-, and cost-saving accommodation of the different components. In addition, due to the accommodation in a shared housing which shields against electromagnetic radiation, there are fewer high-voltage components which must be separately checked and shielded, and it is possible to dissipate heat or to cool as a unit, or to utilize waste heat for heating other components or the vehicle interior. The accommodation of all electronic, electric, electromechanical, or electrochemical components which generate heat losses or waste heat in a shared housing reduces the heat losses to a minimum, or, in other words, maximally increases the utilization of energy. A flow of heat transfer medium passes through the housing, which flow is connected at the outlet to the vehicle interior and/or the battery. A flow of heat transfer medium preferably passes through the housing, which flow is connected at the outlet to the vehicle interior and/or the battery. The device according to the invention provides central thermal energy management in a single housing for a hybrid- or electric vehicle, wherein the heat loss resulting from the energy transmission and/or energy conversion is fed to a flow of heat transfer medium which passes through the housing. The waste heat in this case is fed as completely as possible to a heat transfer medium of the heat transfer flow, and can accordingly be utilized at another location.

Whenever “electronic components” are mentioned in this application, this term shall include electrical, electromechanical or electrochemical devices in each case as well.

It is particularly advantageous that a device for charging the battery (OBC=on-board charger), and further electronic components which are equipped with power electronics, and which thus convert a significant portion of the energy supplied to them into heat loss or waste heat, are arranged in the housing. With the present invention, it is possible for all components that have significant energy losses due to the generation of heat to collectively feed this portion of lost energy to a heater of the vehicle interior and/or a preheater of the battery. The charger circuit of the on-board charger can preferably be used for energizing a heating or cooling element during the charging process, and/or during driving.

The present invention makes it possible to reduce the size of a separate heater, such as a PTC heater, or to omit the same. Eliminating additional components makes it possible to reduce weight, which, in conjunction with optimum battery temperature, can be taken advantage of to increase the vehicle range or reduce the battery size.

The further electronic components particularly preferably comprise at least one PTC heater and/or at least one inverter and/or at least one controller of an air conditioning compressor.

According to a particularly preferred embodiment, the DC/DC converter is designed as a multi-port multi-directional DC/DC converter with a multiple winding transformer, the input portion of which has at least one power electronics component with a primary coil, and the output portion of which has a plurality of power electronics components, each of which is connected to at least one of multiple secondary coils. The power electronics components in this case are preferably designed as a transistor, MOSFET, or an insulated-gate bipolar transistor (IGBT). The multiple winding transformer makes it possible to provide different output voltages for different power electronics components from an input voltage, in an extremely compact manner.

In an advantageous embodiment, the device according to the invention has at least one temperature sensor for detecting the inlet temperature into the housing and/or at least one temperature sensor for detecting the internal temperature of the housing and/or at least one temperature sensor for measuring the outlet temperature from the housing and/or for measuring the temperature of the vehicle interior.

The device for heat recovery particularly preferably has at least one control device comprising a microcontroller. Measured values from the aforementioned temperature sensors are fed to this control device as input signals, and the control device can use these measured values and the specific temperature requirement from the vehicle interior or the operating temperature reported by the vehicle battery to change the efficiency of the device for charging the battery and/or of the at least one further electronic component in a targeted manner, in order to intentionally generate more waste heat in these components when necessary—which can then be used for heating purposes. By means of an intentional worsening of efficiency, electronic components which are not actually intended for the purpose can be used as heating devices, such that there is no need to use separate heating devices, or the size of these heating devices can be significantly reduced.

It is optionally provided that the electronics of at least one of the electronic components can be used to control the power and/or to change the efficiency of another electronic component. As a result, under certain circumstances, a microcontroller may be superfluous in the device according to the invention, since the controller intelligence of some components, which is available already, allows them to be used to control other components without any modification.

The flow of heat transfer medium preferably uses air as the heat transfer medium, but alternatively can also use cooling water or a combination of both. The flow of heat transfer medium can be guided in such a way that the waste heat from the electronic components is absorbed in series or, alternatively, at least partially in parallel. It is particularly advantageous if the components with a lower waste heat temperature are arranged in front of the components with a higher waste heat temperature, such that preferably a cascade with a steadily increasing temperature is formed in the flow of heat transfer medium.

According to an advantageous development, the flow of heat transfer medium can be influenced by means of at least one delivery device, such as a fan or a pump, which in turn is likewise preferably arranged, together with at least its drive motor, in the shared housing. In connection with the power control and the targeted change in the efficiency of the individual electronic components, a change in the delivery rate of the delivery device enables particularly finely metered heat input into the vehicle interior or to the vehicle battery.

The shared housing preferably has, at least partially, a thermal insulation wall. In regions of the housing in which components with high heat generation are arranged, the thermal insulation of the wall can be interrupted, and additional cooling ribs can even be arranged on the housing on the outer side of the wall.

The flow of heat transfer medium emerging from the device can be advantageously divisible by means of a controllable switch for heating the vehicle interior and/or the battery. In this case, depending on the outside temperature and the state of charge of the battery, priorities can be set in the control device for heating (or cooling) the battery or for heating or cooling the vehicle interior.

Optionally, two separate devices according to the invention can also be provided, one of which is used to heat the vehicle interior and another to heat the battery.

Where a warming or heating of the vehicle interior or the battery is mentioned above in connection with the device according to the invention, this expression also includes cooling.

The invention also relates to an advantageous use of a device according to the invention in a hybrid- or electric vehicle.

In the following, embodiments of the device according to the invention are explained in more detail with reference to the drawings, wherein:

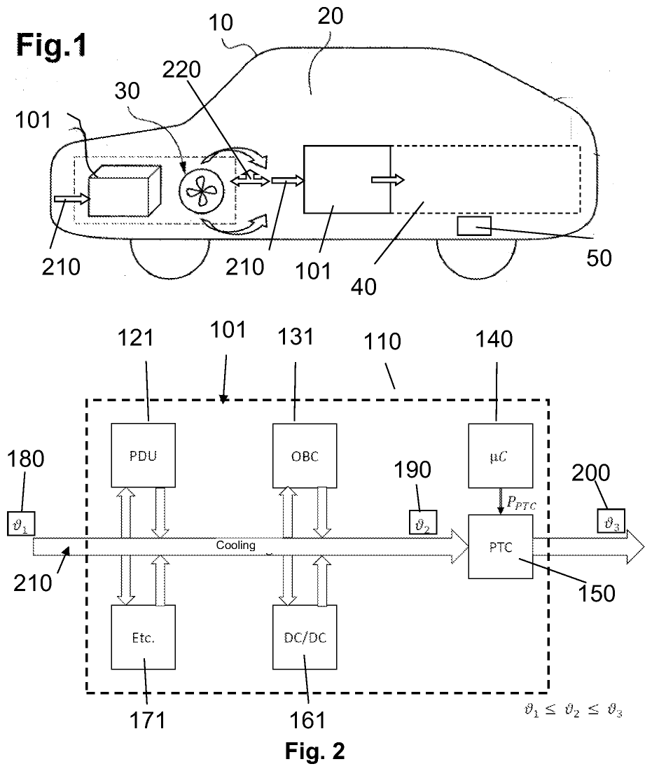

FIG. 1 is a schematic view of a hybrid- or electric vehicle having a vehicle interior, a battery, a drive and two devices according to the invention,

FIG. 2 is a first variant of a device according to the invention, in which a microcontroller controls a PTC heater when required,

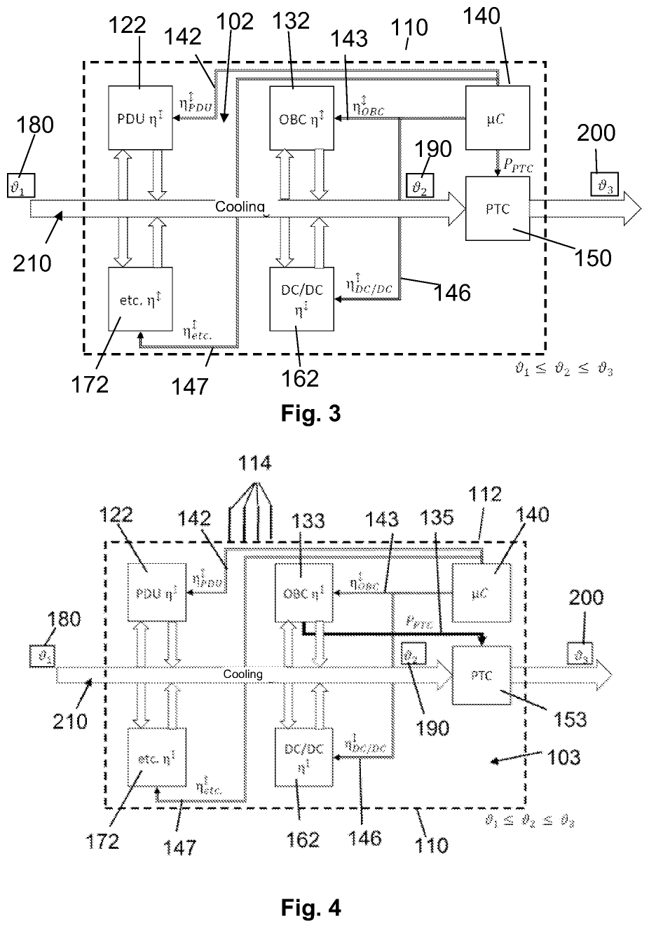

FIG. 3 is a second variant of a device according to the invention, in which a microcontroller specifically influences the degree of efficiency of electronic power components via control lines to increase or decrease their heat output, and

FIG. 4 is a third variant of a device according to the invention, in which, supplementing the second variant, the control electronics of an on-board charger also perform the task of controlling a PTC heater.

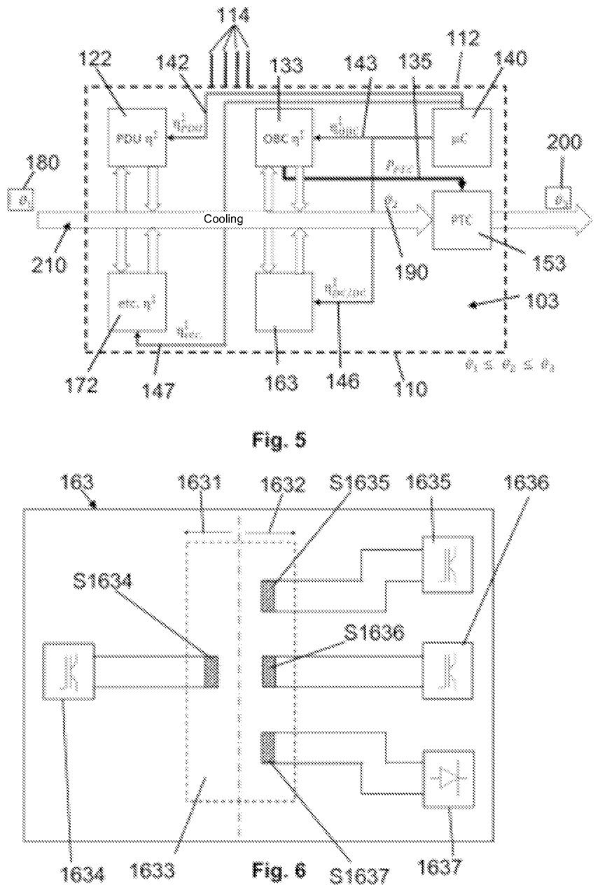

FIG. 5 is a fourth variant of a device according to the invention, in which the DC/DC converter is formed by a multi-port multidirectional DC/DC converter, and

FIG. 6 is a schematic detailed view of the multi-port multidirectional DC/DC converter of FIG. 5.

FIG. 1 schematically illustrates a hybrid- or electric vehicle 10 which has a vehicle interior 20 and which can be moved by means of a drive motor 50 powered by a battery 40. In the hybrid- or electric vehicle 10, two devices 101 according to the invention are also shown schematically, of which several embodiments 101, 102, 103 are shown in detail in FIGS. 2 to 4. Typically, only one of these devices according to the invention is present.

A flow of heat transfer medium 210 passes through the device 101 according to the invention, which flow preferably uses air as the heat transfer medium. However, an alternative or additional use of coolant is possible. As shown in FIG. 1, the flow of heat transfer medium 210 can be varied with respect to the flow rate per unit of time by means of a delivery device, which is indicated in the figure as a fan 30. Optionally, a deflector 220 is provided for dividing the flow of heat transfer medium 210 into variable fractions, of which a first fraction is fed to the vehicle interior 20 and a second fraction is fed to the battery 40.

The device 101 according to the invention has a shared housing 110 which is equipped with a preferably thermally insulating wall 112, and in which all components of the electric vehicle 10 that have power electronics are contained. These are, in particular, an on-board charger (OBC) 131 and/or a unit 121 which distributes energy and provides protection, also known as a power distribution unit (PDU), and/or a DC/DC converter 161, and/or optionally a component 171, which is designated by “etc.” as a representative for further electronic components which can be, for example, formed by the control electronics of an air conditioning compressor.

A control device 140 with a microcontroller and at least one PTC heater 150 is also arranged in the housing 110. The control device 140 controls the power of the PTC heater 150 according to the heat demand for the vehicle interior 20 and/or the battery 40. The PTC heater 150 in this case only has to contribute the difference in thermal energy if the previously generated waste heat of these power components absorbed by a flow of heat transfer medium 210 from the electronic power components 121, 131, 161 and 171 is not sufficient. The PTC heater 150 can also, if necessary, be operated as a PTC cooler 150 in order to maintain components in their optimum operating range by means of cooling. The wall 112 of the housing 110 can have good heat dissipating properties at least in portions thereof, for dissipating heat, and can particularly have additional cooling ribs 114 on the outer side, as noted by way of example in FIG. 4 only.

Temperature signals from a temperature sensor 180 for the inlet temperature ϑ₁ into the housing 110, a temperature sensor 190 for the internal temperature ϑ₂ in the housing 110 upstream of the PTC heater 150, and optionally a temperature sensor 200 for the outlet temperature ϑ₃ from the housing 110 are preferably relayed to the control device 140, such that the control device 140 can control the power of the PTC heater 150 to generate the difference in thermal energy still required in the flow of heat transfer medium 210 before the same exits the housing 110, according to the temperature requirement for the vehicle interior 20 and/or the battery 40.

In the embodiment of the device 101 according to the invention shown in FIG. 2, the flow of heat transfer medium 210 collects the waste heat from all power electronics components 121, 131, 161, 171 inside the housing 110, and the control device 140 controls the PTC heater 150 for a contribution to the thermal energy difference still required before the exit from the housing 110.

In the embodiment of a device 102 according to the invention shown in FIG. 3, the microcontroller of the control device 140 is connected to the PDU 122 via a control line 142, to the OBC 132 via a control line 143, to the DC/DC converter 162 via a control line 146, and is connected to the other electronic component 172 via a control line 147. The control device 140 can in this case influence the efficiency η of the above-mentioned electronic components 122, 132, 162 and 172, and thereby control their heat energy output in a targeted manner. As such, in addition to controlling the PTC heater 150, as known from the first embodiment according to FIG. 2, the controller 140 has the option of essentially using all further power electronics components 122, 132, 162 and 172 arranged in the housing 110 as additional heating devices, by reducing their efficiency n.

In the third embodiment shown in FIG. 4, in the device 103 according to the invention, in addition to the second embodiment according to FIG. 3, the control electronics for the charging management of the battery 40 of the electric vehicle 10 also perform the task of controlling the PTC heater 153 via a control line 135. As a result, the control device 140 can be relieved of tasks, or even made completely irrelevant, if the control of the other electronic power components is taken over by an already existing controller of an electronic power component, such as the OBC 133 in the above example.

According to the embodiment illustrated in FIGS. 5 and 6, the DC/DC converter is designed as a multi-port multi-directional DC/DC converter 163 with a multiple winding transformer 1633, the input portion 1631 of which has at least one power electronics component 1634 with a primary coil S1634, and the output portion 1632 of which has a plurality of power electronics components 1635, 1636 (bidirectional), and/or 1637 (unidirectional), each of which is connected to at least one of two or more secondary coils S1635, S1636, and/or S1637. The power electronics components 1634, 1635, 1636 and/or 1637 in this case are preferably formed by a transistor, MOSFET, or an insulated-gate bipolar transistor (IGBT). The multiple winding transformer 1633 makes it possible to provide different output voltages for the preferably different power electronics components 1635, 1636, 1637 from an input voltage at the primary coil S1634, in an extremely compact manner, by means of different secondary coils S1635, S1636, and/or S1637. For a person skilled in the art, it is clear that the number of three power electronics components 1635, 1636 and/or 1637 shown in the embodiment in FIG. 6 is selected by way of example, and does not limit the invention.

### LIST OF REFERENCE SYMBOLS

10 hybrid- or electric vehicle

20 vehicle interior

30 delivery device (fan)

40 battery

50 drive motor

101 device

102 device

103 device

110 housing

112 wall

114 cooling ribs

121, 122 energy distribution and/or protection unit (PDU)

131 device for charging 40 [on-board charger (OBC)]

132 device for charging 40 [on-board charger (OBC)]

133 device for charging 40 [on-board charger (OBC)]

135 control line (from 133 to 153)

140 control device

142 control line (from 140 to 122)

143 control line (from 140 to 132 or 133)

146 control line (from 140 to 162)

147 control line (from 140 to 172)

150, 153 PTC heater

161, 162 DC/DC converter

163 (multi-port, multidirectional) DC/DC converter

1631 input portion (of 163)

1632 output portion (of 163)

1633 multiple winding transformer

1634 power electronics component

S1634 (primary) coil (of 1634)

1635 power electronics component (bidirectional)

S1635 coil (of 1635)

1636 power electronics component (bidirectional)

S1636 coil (of 1636)

1637 power electronics component (unidirectional)

S1637 coil (of 1637)

171, 172 (further electronic) component

180 temperature sensor (inlet temperature ϑ₁ into 110)

190 temperature sensor (interior temperature ϑ₂)

200 temperature sensor (outlet temperature ϑ₃)

210 flow of heat transfer medium

220 deflector (in 210)

1. A device (101, 102, 103) for energy distribution and/or energy conversion, which is arranged in a hybrid- or electric vehicle (10) having at least one vehicle interior (20) and having at least one battery (40) for driving at least one electric drive motor (50), wherein the device (101, 102, 103) comprises a housing (110) in which at least one electronic, electrical, electromechanical or electrochemical device (121, 122, 131, 132, 133, 161, 162, 171, 172) is arranged, the waste heat of which, generated during energy distribution and/or energy conversion, is fed to a flow of heat transfer medium (210) which passes through the housing (110), which is connected at the outlet to the vehicle interior (20) and/or the battery (40),
and wherein the device (101, 102, 103) comprises at least one control device (140) which comprises a microcontroller (μC) or electronics of one of the at least one electronic, electrical, electromechanical or electrochemical devices (121, 122, 131,132, 133, 161, 162, 171, 172), wherein the control device (140) or the electronics connected to the at least one device (121, 122, 131, 132, 133, 161, 162, 171, 172) can change the degree of efficiency (η) thereof, such that more waste heat can be generated in the at least one electronic, electrical, electromechanical or electrochemical device (121, 122, 131, 132, 133, 161, 162, 171, 172) for heating purposes, by intentionally worsening the degree of efficiency (η).

2. The device according to claim 1, characterized in that an on-board charger device (131, 132, 133) for charging the battery (40), at least one DC/DC converter (161, 162), at least one unit (121, 122) which distributes energy and/or provides protection, and further electronic components (171, 172) are arranged in the housing (110), which devices convert at least a portion of the energy supplied to them into heat.

3. The device according to claim 2, characterized in that the further electronic components comprise at least one PTC heater (150, 153) and/or at least one inverter (171, 172) and/or at least one controller (171, 172) of an air conditioning compressor.

4. The device according to claim 1, characterized in that the device (101, 102, 103) has at least one temperature sensor (180) for detecting the inlet temperature (ϑ₁) into the housing (110) and/or at least one temperature sensor (190) for detecting the interior temperature (ϑ₂) in the housing (110), and/or at least one temperature sensor (200) for measuring the outlet temperature of the heat flow (ϑ₃) from the housing (110) and/or for measuring the temperature of the vehicle interior (20).

5. (canceled)

6. The device according to claim 4, characterized in that measured values from the temperature sensors (180, 190, 200) are relayed to the control device (140) as input signals.

7. The device according to claim 1, characterized in that the control device (140) is connected to the device (131, 132, 133) for charging the battery (40) and/or to the at least one electronic component (121, 122; 131, 132, 133, 161, 162; 171, 172) for the purpose of controlling the power thereof.

8. The device according to claim 1, characterized in that the flow of heat transfer medium (210) uses air and/or cooling liquid as the heat transfer medium.

9. The device according to claim 1, characterized in that the flow of heat transfer medium (210) can be influenced by means of at least one delivery device (30).

10. The device according to claim 1, characterized in that the flow of heat transfer medium (210) exiting a device (101, 102, 103) can be divided by means of a controllable deflector (220) for heating the vehicle interior (20) and/or the battery (40).

11. The device according to claim 1, characterized in that the shared housing has at least one wall (112) with thermal insulation properties.

12. The device according to claim 10, characterized in that the wall (112) has heat-dispersing regions (114).

13. The device according to claim 2, characterized in that the DC/DC converter is designed as a multi-port multi-directional DC/DC converter (163) with a multiple winding transformer (1633), the input portion (1631) of which has at least one power electronics component (1634) with a primary coil (S1634), and the output portion (1632) of which has a plurality of power electronics components (1635, 1636, 1637) each connected to at least one of multiple secondary coils (S1635, S1636, S1637).

14. The device according to claim 13, characterized in that the further electronic components (1634, 1635, 1636, 1637) are formed by a transistor or a MOSFET or an insulated-gate bipolar transistor (IGBT).

15. The use of a device (101, 102, 103) according to claim 1, in a hybrid- or electric vehicle (10).
